(19) United States
(12) Patent Application Publication
(10) Pub. No.: US 2008/0299412 A1
(43) Pub. Date: Dec. 4, 2008

(54) Method for Manufacturing Metal Components and Metal Component

(75) Inventor: Yunfeng Yang, Espoo (FI)

Correspondence Address: MERCHANT & GOULD PC, P.O. BOX 2903, MINNEAPOLIS, MN, 55402-0903, US

(73) Assignee: Valtion Teknillinen Tutkimuskeskus, Espoo (FI)

(21) Appl. No.: 12/064,856

(22) PCT Filed: Aug. 29, 2006
(86) PCT No.: PCT/FI2006/000285

§ 371 Date: May 2, 2008

(30) Foreign Application Priority Data
Aug. 29, 2005 (FI) 20055453

(51) Int. Cl. B32B 15/01; B22D 23/00

(52) U.S. Cl. 428/686; 164/46; 428/615

(57) ABSTRACT

A method for manufacturing metal components (9) by spray forming comprises depositing by spray forming a first layer (8) of a first metal on a mould, and depositing by spray forming a second layer (10) of a second metal on the first layer, wherein the materials to be deposited and the process conditions of the deposition are selected to produce the microstructure of the first layer (8) being optimised for the final use of the first layer surface (7) defined by the mould (2) on which the first layer is deposited, and the microstructure of the second layer (10) differing from that of the first layer and being optimised for the further actions to be performed to the second layer.

### FIELD OF THE INVENTION

The present invention relates to high-performance metal components like die inserts and different kinds of tool parts, and to manufacturing thereof by spray forming technique.

### BACKGROUND OF THE INVENTION

There are many high-performance metal components like die inserts, engine parts and tool heads which necessitate very time consuming and costly production processes due to the extremely severe working conditions. Such components are usually exposed to heavy mechanical and thermal cyclical stresses, mechanical wear and erosion and/or corrosion which all impose special requirements on the material of the component. These together with the complexity of geometry often needed makes the manufacturing processes very challenging. Thus, there is a continuous need for ways to improve the quality of such components and for cutting down the costs and long lead times.

Powder metallurgy is one possible way to make high quality metal materials, but the costs are typically high, and dimensional accuracy is not always satisfactory in making shaped components.

Spray forming is a unique solidification process in which metal melt is atomised by inert gas into droplets of 10-200 microns in size, flying at subsonic speed onto a deposition substrate. Essential in the method is that the spray is rapidly cooled by the gas in a carefully controlled way both during the flight and on deposition so that the solidification of the preform is not dependent on the temperature and/or the thermal properties of the mould surface. The particles arriving at the mould are in such a condition that welding to the already deposited metal is complete and no interparticle boundaries are developed. As a result, high-quality materials are made with fine, equiaxed and homogeneous microstructures. No further hot working or hardening is needed. In addition, by this kind of process net shape components can be fabricated without further processing, because only minimal shrinkage usually occurs in spray formed objects. These features are especially prominent in making high-alloyed metal components.

A basic spray forming process, nowadays called the Osprey™ process, was disclosed in patent GB 1,472,939 from 1975. Later variants of spray forming techniques are also known. For example, U.S. Pat. No. 5,658,506 claims rapid production of a stamping die for shaping sheet metal by spraying tool steel into a ceramic mould cavity to produce a net-shape tool with excellent properties and without the need for further working. U.S. Pat. No. 6,074,194 discloses an example of latest developments in the area of the equipment used for spray forming.

However, despite of those excellent material properties achievable by spray forming techniques, there are also severe problems arising from different needs for different areas or surfaces of a component made by spray forming. Due to the immunity to heat, very high hardness and wear resistance needed in die inserts, working surfaces of tools and engine parts, it is very difficult and time-consuming to machine the back surface of the component not defined by the mould to its desired final shape and surface structure. Also, for example, later welding of the back surface possibly needed for fastening purposes may be very challenging due to the material selection being based on totally different needs of the working surface of the component.

### PURPOSE OF THE INVENTION

It is an object of the present invention to provide a new method for producing high performance metal components by spray forming technique and also to provide such new components, the components having a functionally layered structure with each layer's properties being optimized according to the later purposes of and/or actions to be performed to said layer.

### SUMMARY OF THE INVENTION

The method according to the present invention is characterised by what is presented in claim 1. Respectively, the component according to the present invention is characterised by what is presented in claim 6.

The method of the present invention is intended for manufacturing metal components by spray forming technique. Different kinds of spray forming processes and apparatus for them are well known for a person skilled in the art and thus no detailed description is needed here. The basic principle is to atomise molten metal to small droplets by an inert gas flow to form a spray of rapidly cooling metal droplets, and then direct the spray to a mould for depositing high quality metal with a fine microstructure. Spray forming enables straightforward fabrication of net-shape components consisting of materials with very high hardness and durability as well as good thermal resistance.

According to the present invention, the method comprises firstly depositing by spray forming a first layer of a first metal on a mould, and depositing then by spray forming a second layer of a second metal on the first layer. When starting the deposition of the second layer on the first layer, in practise a mixing layer is first formed. However, it has no practical effect on the component properties. An essential feature of the present invention is that the materials to be deposited and the process conditions of the deposition are selected to produce a microstructure of the first layer being optimised for the final use of the first layer surface defined by the mould, and a microstructure of the second layer differing from that of the first layer and being optimised for the further actions to be performed to the second layer. To summarise, the present invention provides a method for manufacturing components having functionally layered microstructures. A microstructure means herein the types and arrangement of the metal atoms in the deposited material. The microstructure can be controlled by the selection of the material to be sprayed and to some extent also by the adjustment of different process parameters as is known by those familiar with the spray forming techniques. For example, the first layer microstructure of a die insert can be optimised for casting conditions by making it from tool steel comprising iron, carbon, silicon, manganese, chrome, molybdenum and over 1.4% vanadium, as disclosed in WO 2004/035250.

The properties required for the surface of a die insert, for example, to be placed in contact with the casting mass may differ essentially from features needed for enabling further actions to be performed to the back surface of said die insert body. Thus, a great improvement provided by the present invention in comparison with the prior art solutions is that the properties of each layer can be optimised independently. The further actions to be performed to the second layer can include, for example, modifying the geometry of the component back surface by some machining technique or arranging fastening of the component to some external equipment. In addition, the first layer possibly consisting of very expensive special metal can be made thin when the second layer of more standard material forms a support body of the component. Thus, also significant cost benefits are achieved.

In one preferred embodiment the material and process conditions of the second layer deposition are selected to produce a metal microstructure providing better machinability in comparison with the first layer. Particularly the hardness of the material is preferably adjusted to be lower than that of the first layer, thus facilitating machining of the back surface of the component as needed.

Despite the typically high hardness of the first layer, the material toughness can be relatively low. Thus, for reinforcing the component, preferably the material and process conditions of the second layer deposition are selected to produce a metal microstructure providing higher toughness than that of the first layer.

In applications where welding connections are needed on the back surface of a finalised component, the material and process conditions of the second layer deposition are preferably selected to produce a metal microstructure providing better weldability than that of the first layer.

For effective heat transfer via the component in high temperature applications, the material and process conditions of the second layer deposition are preferably selected to produce a metal microstructure providing higher thermal conductivity than that of the first layer.

Those properties described above can be selected all at the same time. It is also possible to implement just some of them. The adjustment of the materials and process parameters of the second layer in order to achieve those properties is well known for those skilled on the art. For example, one good choice for the second layer material is plain carbon steel including about 0.2% carbon. It has both good machinability and weldability.

Also several second layers with different properties can be deposited one on another.

According to the present invention, the metal component produced by spray forming technique comprises a first layer having a first surface defined by the mould on which the first layer was deposited and a microstructure optimised for the final use of the first surface. As an essential feature, the component further comprises at least one second layer on the first layer having a microstructure optimised for the further actions to be performed to the second layer. This kind of functionally layered structure enables separate optimisation of each layer material to match the requirements of the final use of the component or the further actions to be performed to the component.

Particularly, according to the further actions needed to be performed to the second layer, the microstructure of the second layer provides preferably at least one of the better machinability, higher toughness, better weldability and higher thermal conductivity in comparison with the first layer.

### BRIEF DESCRIPTION OF THE DRAWINGS

The accompanying figures, which are included to provide a further understanding of the invention and constitute a part of this specification, together with the description explain the principles of the invention.

FIG. 1 shows a schematic figure of a basic arrangement for spray forming metal components according to the present invention.

FIG. 2 represents a functionally layered metal component according to the present invention.

### DETAILED DESCRIPTION OF THE INVENTION

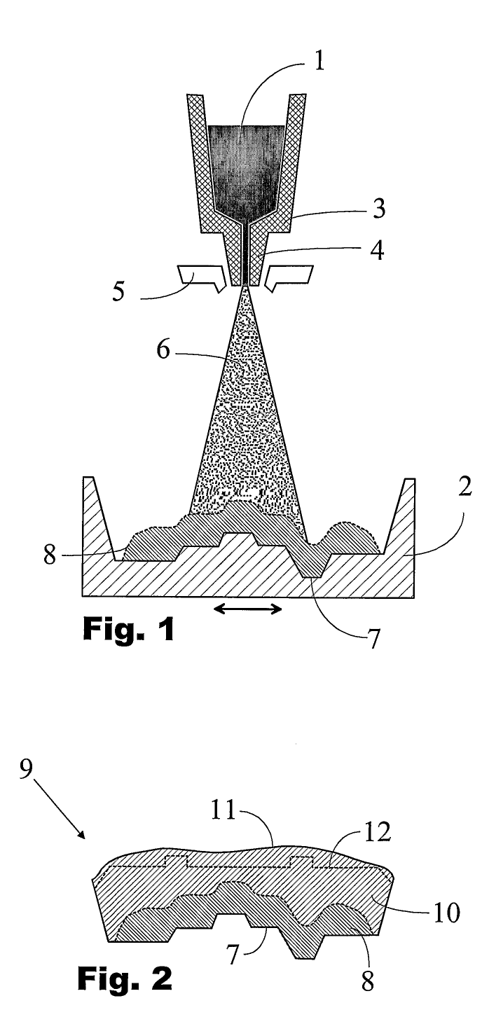

The arrangement of FIG. 1 illustrates the method of spray forming metal components with cooling channels. Molten metal 1 to be sprayed onto a ceramic mould 2 is fed from a heated reservoir 3 through a nozzle 4 and an atomizer 5 where metal is mixed to cool inert gas resulting in a spray 6 of rapidly cooling metal droplets directed to the mould. At the mould 2 the metal is grown with fine and homogenous microstructure producing a near net-shape component surface 7. The mould 2 is movable horizontally with respect to the nozzle 4 for covering by the spray 6 the whole mould area. After deposition of a first layer 8, another molten metal can be inserted in the reservoir for depositing a second layer on the first one having a different microstructure. Naturally, it is also possible to use separate reservoirs (not shown in the figure) and different nozzles for deposition of different layers.

FIG. 2 shows a cross section of a functionally layered metal component 9 made by a spray forming process according to the present invention. The lower surface 7 of the component is defined by the mould on which a first layer 8 of the component has been deposited. The material of the first layer is extremely hard and wear-resistant, consisting for example of some special tool steel, to maximise the durability of the lower surface 7 to be used as the working surface of the component which can be, for example, a die insert or some engine part. A second layer 10 of softer but tougher material having good machining properties has been deposited on the first layer and forms the reinforcing support layer of the component. The free back surface 11 of the second layer has a rather random shape. A further machining step is intended to be applied to the back surface for finalising the component by forming the mounting surface 12 of the component.

1. A method for manufacturing metal components by spray forming technique, wherein the method comprises steps of:
depositing by spray forming a first layer of a first metal on a mould, and
depositing by spray forming a second layer of a second metal on the first layer,
wherein the materials to be deposited and the process conditions of the deposition are selected to produce the microstructure of the first layer being optimised for the final use of the first layer surface defined by the mould on which the first layer is deposited, and the microstructure of the second layer differing from that of the first layer and being optimised for the further actions to be performed to the second layer.

2. A method according to claim 1, wherein the material and process conditions of the second layer deposition are selected to produce a metal microstructure providing better machinability than that of the first layer.

3. A method according to claim 1, wherein the material and process conditions of the second layer deposition are selected to produce a metal microstructure providing higher toughness than that of the first layer.

4. A method according to claim 1, wherein the material and process conditions of the second layer deposition are selected to produce a metal microstructure providing better weldability than that of the first layer.

5. A method according to claim 1, wherein the material and process conditions of the second layer deposition are selected to produce a metal microstructure providing higher thermal conductivity than that of the first layer.

6. A metal component produced by spray forming technique, wherein the component comprises
a first layer having a first surface defined by the mould on which the first layer was deposited, and a microstructure optimised for the final use of the first surface; and
a second layer on the first layer having a microstructure optimised for the further actions to be performed to the second layer.

7. A metal component according to claim 6, wherein the microstructure of the second layer provides better machinability than that of the first layer.

8. A metal component according to claim 6, wherein the microstructure of the second layer provides higher toughness than that of the first layer.

9. A metal component according to claim 6, wherein the microstructure of the second layer provides better weldability than that of the first layer.

10. A metal component according to claim 6, wherein the microstructure of the second layer provides higher thermal conductivity than that of the first layer.
